(19) United States
(12) Patent Application Publication
(10) Pub. No.: US 2011/0235749 A1
(43) Pub. Date: Sep. 29, 2011

(54) ACTIVE ANTENNA ARRAY HAVING ANALOGUE TRANSMITTER LINEARISATION AND A METHOD FOR PREDISTORTION OF RADIO SIGNALS

(76) Inventor: Peter Kenington, Chepstow (GB)

(21) Appl. No.: 12/732,652

(22) Filed: Mar. 26, 2010

(51) Int. Cl. H04L 25/03

(52) U.S. Cl. 375/296

(57) ABSTRACT

An active antenna array for a mobile communications network comprising: a digital signal processor connected to a plurality of digital-to-analogue conversion blocks; a plurality of antenna elements; a plurality of transmission paths, whereby an individual one of the plurality of transmission paths is connected between an individual one of the digital-to-analogue conversion blocks and an individual one of the plurality of antenna elements, whereby an individual one of the plurality of transmission paths comprises a predistorter and a coupler; a plurality of paths connected between an individual one of the couplers and a single combiner; a single feedback path connected between the single combiner and a predistorter coefficient calculation unit; and a coefficient update path connected between the predistorter coefficient calculation unit and at least an individual one of the predistorters.

A method for predistortion of radio signals is also disclosed.

### CROSS-REFERENCE TO OTHER APPLICATIONS

This application is related to concurrently filed U.S. patent application Ser. No. ______ “Active Antenna Array having Analogue Transmitter Linearisation and a Method for Predistortion of Radio Signals” (Attorney Docket No. 4424-P05033US0) and concurrently filed U.S. patent application Ser. No. ______ “Active Antenna Array having a Single DPD Lineariser and a Method for Predistortion of Radio Signals (Attorney docket No. 4424-P05034US0) as well as U.S. patent application Ser. No. 12/648,028 filed on 28 Dec. 2009

The entire contents of the applications are incorporated herein by reference.

### FIELD OF THE INVENTION

The field of the invention relates to an active antenna array and a method for compensation of a plurality of transmit paths in the active antenna array.

### BACKGROUND OF THE INVENTION

The use of mobile communications networks has increased over the last decade. Operators of the mobile communications networks have increased the number of base stations in order to meet an increased demand for service by users of the mobile communications networks. The operators of the mobile communications network wish to reduce the running costs of the base station. One option to do this is to implement a radio system as an antenna-embedded radio forming an active antenna array. Many of the components of the antenna-embedded radio may be implemented on one or more chips.

Nowadays antenna arrays are used in the field of mobile communications systems in order to reduce power transmitted to a handset of a customer and thereby increase the efficiency of the base station, i.e. the radio station. The radio station typically comprises a plurality of antenna elements, i.e. an antenna array adapted for transceiving a payload signal. Typically the radio station comprises a plurality of transmit paths and receive paths. Each of the transmit paths and receive paths are terminated by one of the antenna elements. The plurality of the antenna elements used in the radio station typically allows steering of a beam transmitted by the antenna array. The steering of the beam includes but is not limited to at least one of: detection of direction of arrival (DOA), beam forming, down tilting and beam diversity. These techniques of beam steering are well-known in the art.

The code sharing and time division strategies as well as the beam steering rely on the radio station and the antenna array to transmit and receive within well defined limits set by communication standards. The communications standards typically provide a plurality of channels or frequency bands usable for an uplink communication from the handset to the radio station as well as for a downlink communication from the radio station to the handset. In order to comply with the communication standards it is of interest to reduce so called out of band emissions, i.e. transmission out of a communication frequency band or channel as defined by the communication standards.

For the transmission of the payload signal the base station comprises an amplifier within the transmit paths of the radio station. Typically, each individual one of the transmit paths comprises an individual one of the amplifiers. The amplifier typically introduces nonlinearities into the transmit paths. The nonlinearities introduced by the amplifier affect transfer characteristics of the transmit paths. The nonlinearities introduced by the amplifier distort the payload signal relayed by the radio station as a transmit signal along the transmit paths.

The transfer characteristics of the device describe how the input signal(s) generate the output signal. It is known in the art that the transfer characteristics of a nonlinear device, for example a diode or the amplifier, are generally nonlinear.

The concept of predistortion uses the output signal of the device, for example from the amplifier, for correcting the nonlinear transfer characteristics. The output signal is compared to the input signal by means of feedback and from this comparison correction coefficients are generated which are used to form or update an “inverse distortion” which is added and/or multiplied to the input signal in order to linearise the transfer characteristics of the device. The nonlinear transfer characteristics of the amplifier can be corrected by carefully adjusting the predistortion by means of the feedback.

To apply a correct amount of the predistortion to the amplifier it is of interest to know the distortions or nonlinearities introduced by the amplifier. This is commonly achieved by the feedback of the transmit signal to a predistorter. The predistorter is adapted to compare the transmitted signal with a signal prior to amplification in order to determine the distortions introduced by the amplifier. The signal prior to amplification is, for example, the payload signal.

The concept of the predistortion has been explained in the above description in terms of correcting the transfer characteristics with respect to the amplitude of the transmit signal. It is understood that predistortion may alternatively and/or additionally correct for nonlinearities with respect to a phase of the input signal and the output signal.

The nonlinearities of the transfer characteristics of the complete transmit path from a digital signal processor to the antenna element are typically dominated by the nonlinearities in the transfer characteristics of the amplifier. It is therefore often sufficient to correct for the nonlinearities of the amplifier.

### SUMMARY OF THE INVENTION

The disclosures provides for an active antenna array for a mobile communications network comprising a digital signal processor connected to a plurality of digital-to-analogue conversion blocks and a plurality of antenna elements. A plurality of transmission paths are provided, whereby an individual one of the plurality of transmission paths is connected between an individual one of the digital-to-analogue conversion blocks and an individual one of the plurality of antenna elements. An individual one of the plurality of transmission paths comprises a predistorter and a coupler. The active antenna array comprises a plurality of paths connected between an individual one of the couplers and a single combiner. A single feedback path is connected between the single combiner and a predistorter coefficient calculation unit; and a coefficient update path is connected between the predistorter coefficient calculation unit and at least an individual one of the predistorters.

In one aspect of the invention, the combiner is one of a multi-way switch or an adder.

The digital to analogue conversion block may be one of a digital-to-analogue converter, a delta-sigma digital-to-analogue converter or a pair of digital-to-analogue converters supplying I & Q signals.

The pre-distorter coefficient calculation unit may be preferably located within the digital signal processor.

In another aspect of the invention the active antenna array comprises a predistorter control system for controlling the predistorter. The predistorter control system may comprise at least one of an amplitude controller and a phase controller.

The disclosure also provides for a method for predistortion of radio signals. The method comprises predistorting two or more of a plurality of analogue payload signals, thereby obtaining at least two predistorted payload signals; amplifying the at least two predistorted payload signals; extracting a portion of one or more of the at least two predistorted payload signals as a single feedback signal, and adapting the predistorting of the two or more of the plurality of analogue payload signals by comparing the single feedback signal with at least one of the two or more of the plurality of analogue payload signals.

In one aspect of the disclosure, the method comprises switching between individual ones of the feedback signals; and using the switched one of the individual ones of the feedback signals for adapting the predistorting of a corresponding one of the plurality of analogue payload signals.

In another aspect of the invention, the method comprises forming an composite feedback signal from a plurality of the at least one predistorted payload signals; and using the composite feedback signal for adapting the predistorting of a plurality of the analogue payload signals.

The disclosure also provides for a computer program product comprising a non-transitory computer-usable medium having control logic stored therein for causing a computer to manufacture an active antenna array for a mobile communications network, the active antenna array comprising:
a digital signal processor connected to a plurality of digital-to-analogue conversion blocks;
a plurality of antenna elements;
a plurality of transmission paths, whereby an individual one of the plurality of transmission paths is connected between an individual one of the digital-to-analogue conversion block and an individual one of the plurality of antenna elements, whereby an individual one of the plurality of transmission paths comprises a predistorter and a coupler;
a plurality of paths connected between an individual one of the couplers and a single combiner
a single feedback path connected between the single combiner and a predistorter coefficient calculation unit; and
a coefficient update path connected between the predistorter coefficient calculation unit and at least an individual one of the predistorters.

In a further aspect of the disclosure, a computer program product comprises a non-transitory computer-usable medium having control logic stored therein for causing an active antenna to execute a method for receiving a plurality of individual radio signals comprising:
first computer readable code means for predistorting two or more of a plurality of analogue payload signals, thereby obtaining at least two predistorted payload signal;
second computer readable code means for amplifying the at least two predistorted payload signal;
third computer readable code means for extracting a portion of one or more of the at least two predistorted payload signal as a single feedback signal;
fourth computer readable control means for adapting the predistorting of the two or more of the plurality of analogue payload signals by comparing the single feedback signal with at least one of the two or more of the plurality of analogue payload signals.

### DESCRIPTION OF THE FIGURES

FIG. 1 shows a first aspect of an active array antenna according to the present disclosure.

FIG. 2 shows a further aspect of the active array antenna according to the present disclosure.

FIG. 3 shows a further aspect of the active array antenna according to the present disclosure.

FIG. 4 shows a further aspect of the active array antenna according to the present disclosure.

FIG. 5 shows a further aspect of the active array antenna according to the present disclosure

FIG. 6 shows an example of polynomial predistorter that can be used in one aspect of the disclosure.

FIG. 7 shows detailed view of how the third and fifth order non-linearities shown in FIG. 6 could be realized in one aspect of the disclosure.

FIG. 8. shows a method for linearising a payload signal according to the present disclosure.

FIG. 9. shows an overview of the method according to one aspect of this disclosure

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature or features of a different aspect or aspects and/or embodiments of the invention.

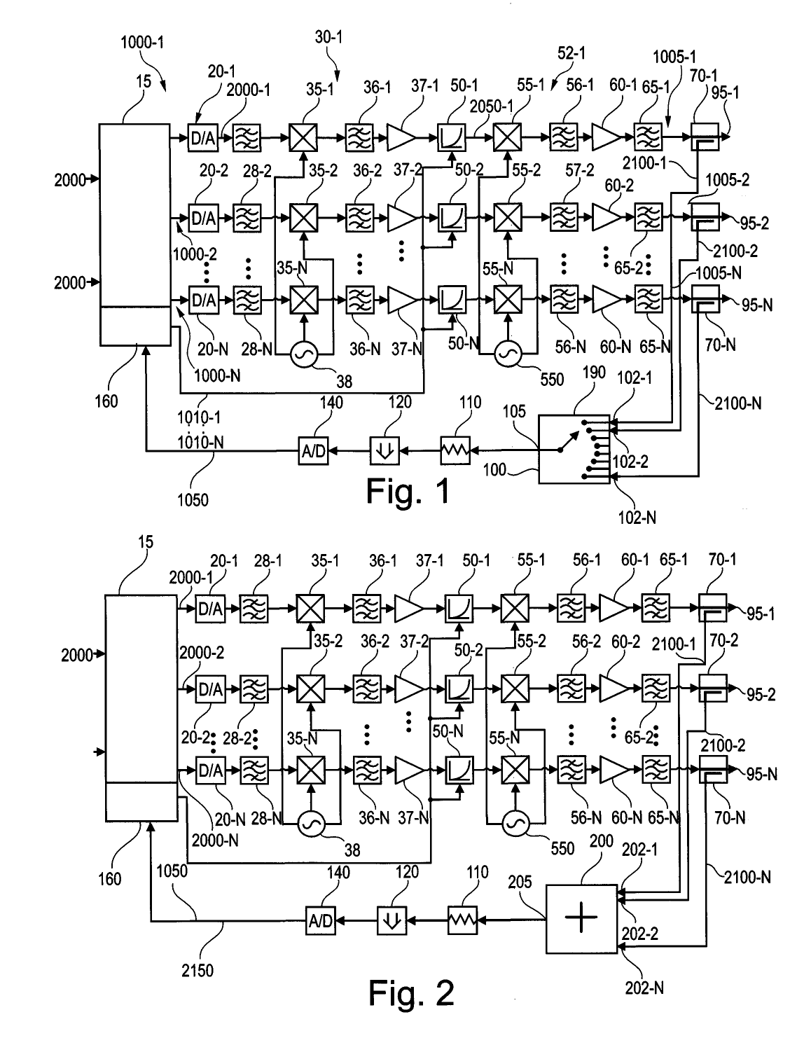

FIG. 1 shows a first aspect of an active antenna array 1 according to the present disclosure. A digital signal processor (DSP) 15 receives and processes a payload signal 2000.

The payload signal 2000 typically comprises an in phase portion (I) and an out of phase portion, i.e. a quadrature portion (Q). The digital formats for the payload signal 2000 in an (I, Q) format are known in the art and will not be explained any further.

The active antenna array 1 as shown in FIG. 1 comprises at least one transmit path 1000-1, 1000-2, . . . , 1000-N. There are three different transmit paths 1000-1, 1000-2, . . . , 1000-N displayed within FIG. 1. It will however be appreciated by the person skilled in the art that the number of transmit paths 1000-1, 1000-2, . . . , 1000-N can be changed. In a typical implementation there will be eight or sixteen transmit paths, but this is not limiting of the invention. Each one of the transmit paths 1000-1, 1000-2, . . . , 1000-N is terminated by an antenna element 95-1, 95-2, . . . , 95-N.

In a transmit path 1000-1, 1000-2, . . . , 1000-N the payload signal 2000 is processed by the digital signal processor 15, for example undergoing filtering, upconversion, crest factor reduction and beamforming processing, prior to being forwarded to a digital-to-analogue conversion block 20-1, 20-2, . . . , 20-N adapted to convert the payload signal 2000 into an analogue payload signal 2000-1, 2000-2, . . . , 2000-N as a transmit signal. The analogue payload signal 2000-1, 2000-2, . . . , 2000-N may be provided as pairs of amplitude and phase values (A, P). The payload signal 2000 is not changed by the selected form of the payload signal 2000 i.e. (I,Q) or pairs of phase and amplitude (A, P).

The digital-to-analogue conversion block 20-1, 20-2, . . . , 20-N may comprise conventional digital-to-analogue converters 20-1, 20-2, . . . , 20-N. Alternately, the digital-to-analogue conversion block 20-1, 20-2, . . . , 20-N may be in the form of delta-sigma digital-to-analogue converters.

The analogue payload signal 2000-1, 2000-2, . . . , 2000-N is passed to a transmission path 1005-1, 1005-2, . . . , 1005-N. Each one of the transmission paths 1005-1, 1005-2, . . . , 1005-N is connected between a digital-to-analogue conversion block 20-1, 20-2, . . . , 20-N and an antenna element 95-1, 95-2, . . . , 95-N.

The transmission paths 1005-1, 1005-2, . . . , 1005-N comprises a first filter 28-1, 28-2, . . . , 28-N. The first filter 28-1, 28-2, . . . , 28-N may be any filter adapted to appropriately filter the analogue payload signal 2000-1, 2000-2, . . . , 2000-N leaving the digital-to-analogue conversion block 20-1, 20-2, . . . , 20-N after conversion of the payload signal 2000 into an analogue form. Typically, the first filter 28-1, 28-2, . . . , 28-N comprises a band pass filter. The first filter 28-1, 28-2, . . . , 28-N allows the analogue payload signal 2000-1, 2000-2, . . . , 2000-N to pass the first filter 28-1, 28-2, . . . , 28-N in a group of frequency bands or channels as defined by the communication standard, such as for example 3GPP. The purpose of the first filter 28-1, 28-2, . . . , 28-N is to remove unwanted products from the digital to analogue conversion process, such as noise or spurious signals.

The output of the first filter 28-1, 28-2, . . . , 28-N is passed to an up-conversion block 30-1, 30-2, . . . , 30-N. The up-conversion block 30-1, 30-2, . . . , 30-N is adapted for up-converting the analogue payload signal 2000-1, 2000-2, . . . , 2000-N. The up-conversion block 30-1, 30-2, . . . , 30-N comprises an up-mixer 35-1, 35-2, . . . , 35-N along with a filter 36-1, 36-2, . . . , 36-N. The up mixers 35-1, 35-2, . . . , 35-N are known in the art and will not be discussed further within this disclosure. The up-conversion block 30-1, 30-2, . . . , 30-N comprises a local oscillator input port and this input port receives a local oscillator signal from the local oscillator 38. Three signal up-conversion blocks 30-1, 30-2, . . . , 30-N are shown in FIG. 1, all of which are connected to a single local oscillator 38. Having a single local oscillator 38 ensures that the analogue payload signals 2000-1, . . . , 2000-N on each one of the transmission paths 1005-1, 1005-2, . . . , 1005-N is up-converted coherently.

The output of the up-conversion block 30-1, 30-2, . . . , 30-N, is amplified in an amplifier 37-1, 37-2, . . . , 37-N and passed to an analogue predistorter 50-1, 50-2, . . . , 50-N. The analogue predistorter 50-1, 50-2, . . . , 50-N is adapted to impose at least one predistortion onto the analogue payload signal 2000-1, 2000-2, . . . , 2000-N thus forming the predistorted payload signal. There are three analogue predistorters 50-1, 50-2, . . . , 50-N and three predistorted payload signals shown in FIG. 1. Any other number of the predistortions and/or predistorted payload signals is conceivable. The predistorted payload signals are relayed along the transmission paths 1005-1, 1005-2, . . . , 1005-N as transmit signals.

In the aspect of the invention shown in FIG. 1, the up-conversion block 30-1, 30-2, . . . , 30-N is adapted to convert the analogue payload signal 2000-1, 2000-2, . . . , 2000-N into an intermediate frequency payload signal and the analogue predistorter 50-1, 50-2, . . . , 50-N is adapted to work in the intermediate frequency range.

One of the analogue predistorters 50-1, 50-2, . . . , 50-N are provided for each one the transmission paths 1005-1, 1005-2, . . . , 1005-N. The analogue predistorters 50-1, 50-2, . . . , 50-N enable individual linearization of each one of the transmit paths 1005-1, 1005-2, . . . , 1005-N to be undertaken.

In FIG. 1, the output of the analogue predistorter 50-1, 50-2, . . . , 50-N is passed into a second up-conversion block 52-1, 52-2, . . . , 52-N. The second up-conversion block 52-1, 52-2, . . . , 52-N is adapted to convert the predistorted payload signal 2050 from the intermediate frequency range to a RF frequency range. Each one of the up-conversion blocks 52-1, 52-2, . . . , 52-N comprises a up-mixer 55-1, 55-2, . . . , 55-N along with a filter 56-1, 56-2, . . . , 56-N. The up-mixers 55-1, 55-2, . . . , 55-N are known in the art and will not be discussed further within this disclosure. The up-conversion block 52-1, 52-2, . . . , 52-N receives a local oscillator signal from the local oscillator 550. Three signal up-conversion blocks 52-1, 52-2, . . . , 52-N are shown in FIG. 1, all of which are connected to a single local oscillator 550. Having a single local oscillator 550 ensures that the up-converted payload signal on each one of the transmission paths 1005-1, 1005-2, . . . , 1005-N is up-converted coherently.

FIG. 1 shows an active array antenna with a transmission path 1005-1, 1005-2, . . . , 1005-N comprising two up-conversion blocks 30-1, 30-2, . . . , 30-N and 52-1, 52-2, . . . , 52-N. However, it will be appreciated that the present invention should not be limited to a given number of up-conversion blocks. There may be transmission paths 1005-1, 1005-2, . . . , 1005-N with no up-conversion blocks. Alternately, there may be transmission paths 1005-1, 1005-2, . . . , 1005-N with one or more up-conversion blocks 30-1, 30-2, . . . , 30-N and 52-1, 52-2, . . . , 52-N, depending on the active antenna array requirements.

The transmission path 1005-1, 1005-2, . . . , 1005-N further comprises an amplifier 60-1, 60-2, . . . , 60-N as well as a filter 65-1, 65-2 . . . , 65-N and a coupler 70-1, 70-2, . . . , 70-N. The transfer characteristics of the amplifiers 60-1, 60-2, . . . , 60-N are typically designed to be as identical as possible for each one of the transmission paths 1005-1, 1005-2, . . . , 1005-N. Typically a group of the amplifiers 60-1, . . . , 60-N is fabricated in a single batch. The use of the amplifiers 60-1, 60-2, . . . , 60-N belonging to the single batch increases the likelihood of the amplifiers 60-1, 60-2, . . . , 60-N having substantially identical characteristics. This is most notably the case if the amplifiers 60-1, 60-2, . . . , 60-N are fabricated using monolithic semiconductor, hybrid or integrated circuit techniques.

The filter 65-1, 65-2 . . . , 65-N may be any filter adapted to appropriately filter the up-converted transmit signal leaving the amplifier 60-1, 60-2, . . . , 60-N after an amplification of the predistorted payload signal. Typically, the filter 65-1, 65-2, . . . , 65-N comprises a band pass filter to remove out of band signals and it may form part of a duplexer arrangement, with the receive filtering aspects not shown in FIG. 1. The filter 65-1, 65-2, . . . , 65-N allows the up-converted transmit signal to pass the filter 65-1, 65-2, . . . , 65-N in a group of frequency bands or channels as defined by the communication standard 3GPP.

The coupler 70-1, 70-2, . . . , 70-N is adapted to extract a portion of the up-converted transmit signal as a feedback signal 2100-1, 2100-2, . . . , 2100-N out of the transmission path 1005-1, 1005-2, . . . , 1005-N. The coupler 70-1, 70-2, . . . , 70-N is known in the art and may, for example, comprise a circulator or a directional coupler. Obviously any other form of coupler 70-1, 70-2, . . . , 70-N is appropriate for use with the present disclosure, provided the coupler 70-1, 70-2, . . . , 70-N allows the extraction of a feedback signal 2100-1, 2100-2, . . . , 2100-N out of the up-converted transmit signal. The feedback signal 2100-1, 2100-2, . . . , 2100-N is passed to a combiner 100.

In the first aspect of the disclosure shown on FIG. 1, the combiner is a switch 100. The switch 100 comprises a plurality of switch inputs 102-1, 102-2, . . . , 102-N and one switch output 105. The switch 100 is adapted to forward a selected one of a plurality of input signals (i.e. the feedback signal 2100-1, 2100-2, . . . , 2100-N) from the switch inputs 102-1, . . . , 102-N to the switch output 105. In FIG. 1 the selected one of the feedback signals 2100-1, 2100-2, . . . , 2100-N at the switch inputs 102-1, . . . , 102-N is forwarded to the switch output 105.

The switch 100 may be switched from one of the switch inputs 102-1, . . . , 102-N to the next one of the switch inputs 102-1, . . . , 102-N in a sequential switching manner. If the highest switch input 102-N is reached the switch returns to the first switch input 102-1 and vice versa. It is also possible to operate the switch 100 in a non-sequential manner and this may be advantageous where there is merit in concentrating linearization upon a particular transmission path or paths 1005-1, 1005-2, . . . , 1005-N, for example by visiting certain switch settings more frequently than others. This could occur, for example, where one or more of the transmission paths 1005-1, 1005-2, . . . , 1005-N has a greater impact upon the overall spectral output of the active antenna array 1 due to, for example, the use of a higher power amplifier in that transmission path (or paths) 1005-1, 1005-2, . . . , 1005-N.

The selected one of the feedback signals 2100-1, 2100-2, . . . , 2100-N is fed into a common feedback path 1050 leading from the switch output 105 to a predistortion coefficient calculation unit 160 for the analogue predistorter 50-1, . . . , 50-N.

The common feedback path 1050 comprises an attenuator 110. The attenuator 110 serves to reduce a power level of the selected one of the feedback signals 2100-1, 2100-2, . . . , 2100-N. The attenuator 110 may be useful to assure that the selected one of the feedback signal 2100-1, 2100-2, . . . , 2100-N does not exceed a power rating of the predistortion coefficient calculation unit 160. It should be noted that the attenuator 110 should be of a substantially linear transfer characteristic over the frequency and power range of transmission of the active antenna array 1. The linear transfer characteristics of the attenuator 110 prevents further nonlinearities being introduced to the selected one of the feedback signal 2100-1, 2100-2, . . . , 2100-N stemming from the attenuator 110.

The common feedback path 1050 comprises a down-converting and filtering unit 120 adapted to convert the selected one of the feedback signals 2100-1, 2100-2, . . . , 2100-N back to lower frequencies and to filter the out of band signals. The common feedback path 1050 further comprises an analogue-to-digital converter 140. Any analogue-to-digital converter 140 may be used, either conventional or in the form of a delta-sigma analogue-to-digital converter. It is convenient to place the analogue-to-digital converter 140 downstream of the attenuator 110. It would also be possible to place the analogue-to-digital converter 140 upstream from the attenuator 110. Placing the analogue-to-digital converter 140 downstream of the attenuator 110 allows provision of a defined power level of the selected one of the feedback signals 2100-1, 2100-2, . . . , 2100-N for all of the transmission paths 1005-1, 1005-2, . . . , 1005-N. The defined power level of the selected one of the feedback signals 2100-1, 2100-2, . . . , 2100-N may be of interest in order to use a full dynamic range of the analogue-to-digital converter 140, as is known in the art.

The output of the analogue-to-digital converter 140 is passed to the predistortion coefficient calculation unit 160 for processing. The predistortion coefficient calculation unit 160 is adapted to update the predistortions imposed onto the payload signal for forming the predistorted payload signal. The predistortion coefficient calculation unit 160 may be implemented using the DSP 15.

The use of the common feedback path 1050 reduces the complexity of the radio station 1. Individual feedback paths are no longer needed for each individual one of the transmission paths 1005-1, 1005-2, . . . , 1005-N, i.e for each individual one of the feedback signals 2100-1, 2100-2, . . . , 2100-N. Each one of the feedback signals 2100-1, 2100-2, . . . , 2100-N is a representation of the nonlinearities accumulated along an individual one of the transmission paths 1005-1, 1005-2, . . . , 1005-N. The selected one of the feedback signal 2100-1, 2100-2, . . . , 2100-N represents one of the transmission paths 1005-1, 1005-2, . . . , 1005-N.

With the active antenna array 1 of FIG. 1, only one predistortion coefficient calculation unit 160 is needed with the common feedback path 1050, which reduces complexity and hardware cost of the active antenna array 1 as well as saving real estate on the chip.

There may be one or more DSPs 15 used forming the predistortion coefficient calculation unit 160 and the beamforming and digital up-conversion of the input signal.

The predistortions may be stored as a number in a lookup table or as a table of polynomial coefficients describing the nonlinearities of the predistortions. The predistortion coefficient calculation unit 160 is adapted to compare the selected one of the feedback signals 2100-1, 2100-2, . . . , 2100-N with the payload signal 2000. Subsequently, the predistortion coefficient calculation unit 160 is adapted to extract the nonlinearities between a selected one of the feedback signal 2100-1, 2100-2, . . . , 2100-N and the payload signal 2000 and to adjust a selected one of the predistortions, if necessary. It should be noted that the comparison may be performed with a modified version of the payload signal 2000 and not the payload signal 2000 itself. This will be the case where signal processing has taken place upon the payload signal 2000 prior to it leaving the DSP 15. Examples of the signal processing which could take place upon the payload signal 2000 within the DSP 15 include, but are not limited to: filtering, upconversion, crest factor reduction and beamforming processing.

The predistortions are forwarded on a coefficient update path 1010-1, 1010-2, . . . , 1010-N to the predistorter. The predistortion coefficients are converted into analogue predistortion coefficients and fed into the selected one the predistorter 50-1, 50-2, . . . , 50-N. There are as many coefficient update paths 1010-1, 1010-2, . . . , 1010-N as predistorters 50-1, 50-2, . . . , 50-N (three are shown on FIG. 1).

The switch 100 is switched from one of the switch inputs 102-1, . . . , 102-N to the next in a sequential switching (or otherwise, as described above). An iterative process can be implemented, with each one of the predistorters 50-1, . . . , 50-N being updated with the predistortion coefficient calculation unit 160 compiling new coefficients for the selected one of the predistorters 50-1, . . . , 50-N corresponding to the selected one of the transmission paths 1005-1, 1005-2, . . . , 1005-N.

With the active antenna 1 of FIG. 1, the predistortion process is an analogue IF process, which may be controlled locally instead of being controlled by a central DSP resource for power amplifier linearization. Additionally, only a set of predistortion coefficients is required for each one of the analogue predistorters 50-1, 50-2, . . . , 50-N instead of a broadband predistortion multiplication process covering the entire wanted spectrum when the predistortion process is undertaken in the central DSP (e.g. as ‘digital baseband predistortion’ or ‘digital IF predistortion’).

FIG. 2 shows an alternative aspect of the active antenna array 1. The alternative aspect of the active antenna array 1 of FIG. 2 differs from FIG. 1 in that the single combiner is an RF adder 200 instead of the switch 100 of FIG. 1. Those elements of FIG. 2 which are identical to the elements of FIG. 1 have identical reference numerals.

The adder 200 comprises a plurality of adder inputs 202-1, 202-2, . . . , 202-N and one adder output 205. In this aspect of the disclosure, the adder 200 performs a summation of all the feedback signal 2100-1, 2100-2, . . . , 2100-N at the plurality of adder inputs 202-1, 202-2, . . . , 202-N. In other words, a parallel averaging over the plurality of the feedback signals 2100-1, 2100-2, . . . , 2100-N is performed. The output 205 of the adder 200 is a single composite feedback signal 2150 as a composite of the nonlinearities over the plurality of the transmission paths 1005-1, 1005-2, . . . , 1005-N. It is possible for the summation process to be ‘weighted’, i.e. for some inputs to the adder 200 to have a greater representation in the adder output 205 than others. This may be desirable in cases where the amplifier power levels from the RF power amplifiers, 60-1, 60-2, . . . , 60-N, differ from one another, leading to some having a greater contribution than others to the unwanted out-of-band emissions from the active antenna system 1.

The adder output 205 is fed on the feedback path 1050 to the predistortion coefficient calculation unit 160 of the predistorters 50-1, . . . , 50-N. The predistortion coefficient calculation unit 160 is adapted to update the predistortions imposed onto the payload signal 2000 forming the predistorted payload signal. The predistortion coefficient calculation unit 160 may be implemented using the DSP 15.

As noted above, the predistortions may be represented as a number of lookup tables or a number of tables of polynomial coefficients describing the nonlinearities of the predistortions. The predistortion coefficient calculation unit 160 is adapted to compare the adder output 205 averaging the feedback signal 2100-1, 2100-2, . . . , 2100-N with the payload signal 2000 (or a modified version thereof, as noted previously). Subsequently, the predistortion coefficient calculation unit 160 is adapted to extract the nonlinearities between adder output 205 and the payload signal 2000 (or a modified version thereof, as noted previously) and to adjust the predistortions, if necessary, simultaneously for the plurality of predistorters.

In the aspect of FIG. 2, each of the plurality of predistorters 50-1, 50-2, . . . , 50-N, receives the same set of predistortion coefficients or is set at the same predistortion values, based on the averaging of the feedback signal 2100s. The predistorters 50-1, 50-2, . . . , 50-N are updated simultaneously (or at a similar time and with the same values). This is in contrast to the active array antenna of FIG. 1 where only a selected one of the feedback signals 2100-1, 2100-2, . . . , 2100-N at the switch inputs 102-1, . . . , 102-N is forwarded to the switch output 105, and only the selected one of the analogue predistorters 50-1, 50-2, . . . , 50-N is updated with new predistortion coefficient compiled in the predistortion coefficient calculation unit 160 for the selected one of the transmission paths 1005-1, 1005-2, . . . , 1005-N.

The simultaneous (or quasi-simultaneous) update of the analogue predistorters 50-1, 50-2, . . . , 50-N reduces the complexity of the overall system because the adder 200 is a simple component, easily fabricated, which does not require any form of control compared to the switch 100 of FIG. 1.

It is to be noted in the active antenna array 1 of FIG. 2 that the simultaneous update of the analogue predistorters 50-1, 50-2, . . . , 50-N with same predistortion coefficients for each of the analogue predistorters 50-1, 50-2, . . . , 50-N can be contemplated because in radio transmission, it is not necessary for each one of the antenna elements to meet the standard requirements of the radio transmission but for the output signal to be a composite of each individual signal from the plurality of antenna elements 95-1, 95-2, . . . , 95-N forming the active antenna array 1. A simultaneous update of the analogue predistorters 50-1, 50-2, . . . , 50-N helps in reducing the complexity of the active antenna array 1, because there is no need for additional storage memory necessary for storing the different predistortion coefficients of a selected one of the analogue predistorter 50-1, 50-2, . . . , 50-N when a switch 100 is used. Furthermore, all of the DSP processing effort devoted to the predistortion system can be concentrated on a single feedback signal, thereby improving the accuracy of the predistortion updating process.

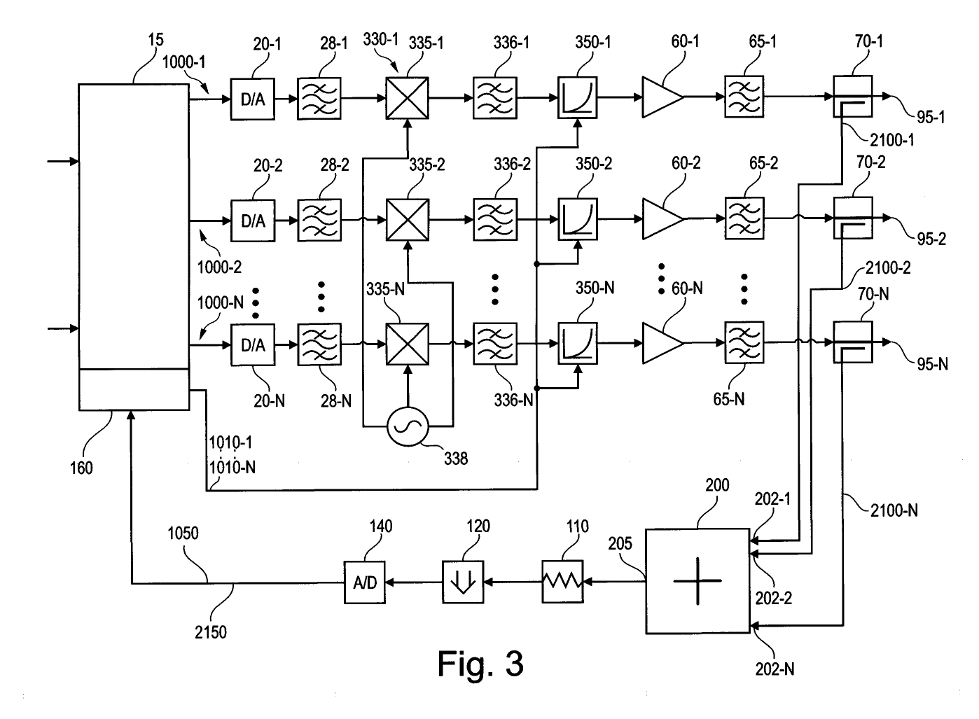

FIG. 3 shows an alternative aspect of the active antenna array 1. The alternative aspect of the active antenna array 1 of FIG. 3 differs from FIG. 2 in that there is only one stage of analogue up-conversion instead of two stages of analogue up-conversion as shown in FIG. 2. Accordingly, the transmission path 1005-1, 1005-2, . . . , 1005-N of the active antenna array 1 of FIG. 3 comprises a single up-conversion block 330-1, 330-2, . . . , 330-N, upstream of the predistorter 50-1, 50-2, . . . , 50-N. The up-conversion block 330-1, 330-2, . . . , 330-N comprises an up-mixer 335-1, 335-2, . . . , 335-N along with a filter 336-1, 336-2, . . . , 336-N. The up mixers 335-1, 335-2, . . . , 335-N are known in the art and will not be discussed further within this disclosure. The up-conversion block 330-1, 330-2, . . . , 330-Ns comprises a local oscillator input and receives the local oscillator signal from the local oscillator 338. Three signal up-conversion blocks 330-1, 330-2, . . . , 330-N are shown, all connected to the single local oscillator 338.

The up-conversion block 330-1, 330-2, . . . , 330-N is adapted to convert the payload signal to a radio frequency band.

A further difference of the active array antenna 1 of FIG. 3 from that of FIG. 2 is that the predistorter 350-1, 350-2, . . . , 350-N is adapted to work in the radio frequency range.

The output of the predistorter 350-1, 350-2, . . . , 350-N is passed to the RF amplifier 60-1, 60-2, . . . , 60-N, filtered through filter 65-1, 65-2, . . . , 65-N and passed to coupler 70-1, 70-2, . . . , 70-N. The coupler 70-1, . . . , 70-N is adapted to extract a portion of the upconverted transmit signal as the feedback signal 2100-1, 2100-2, . . . , 2100-N out of the transmission path 1005-1, 1005-2, . . . , 1005-N. The feedback signal 2100-1, 2100-2, . . . , 2100-N is passed to the adder 200 for further processing, similar to that described above with reference to FIG. 2. It will, of course, be appreciated that the adder 200 could be replaced by the switch 100 as known from the aspect of the invention described in FIG. 1.

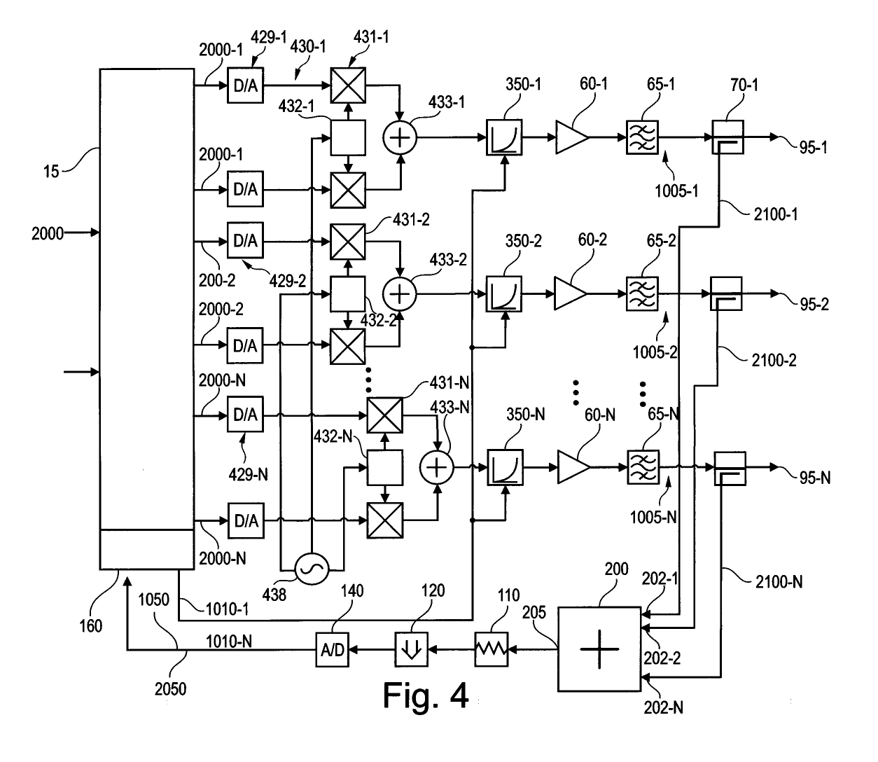

FIG. 4 shows an alternative aspect of the active antenna array 1. The alternative aspect of the active antenna array 1 of FIG. 4 differs from FIG. 3 in that the digital-to-analogue converters 20-1, 20-2, . . . , 20-N and the up-conversion block 330-1, 330-2, . . . , 330-N are replaced by a pair of digital-to-analogue converters 429-1, 429-2, . . . , 429-N and quadrature up-converters 431-1, 431-2, . . . , 431-N supplying RF signals at the outputs 433-1, 433-2, . . . , 433-N. A local oscillator 438 supplies an oscillator signal to the pair of up-converter mixers 431-1, 431-2, . . . , 431-N via the quadrature splitter 432-1, 432-2, . . . , 432-N. The digital-to-analogue converters 429-1, 429-2, . . . , 429-N and quadrature splitters 432-1, 432-2, . . . , 432-N can take a number of forms; these are known in the art and will not be explained any further.

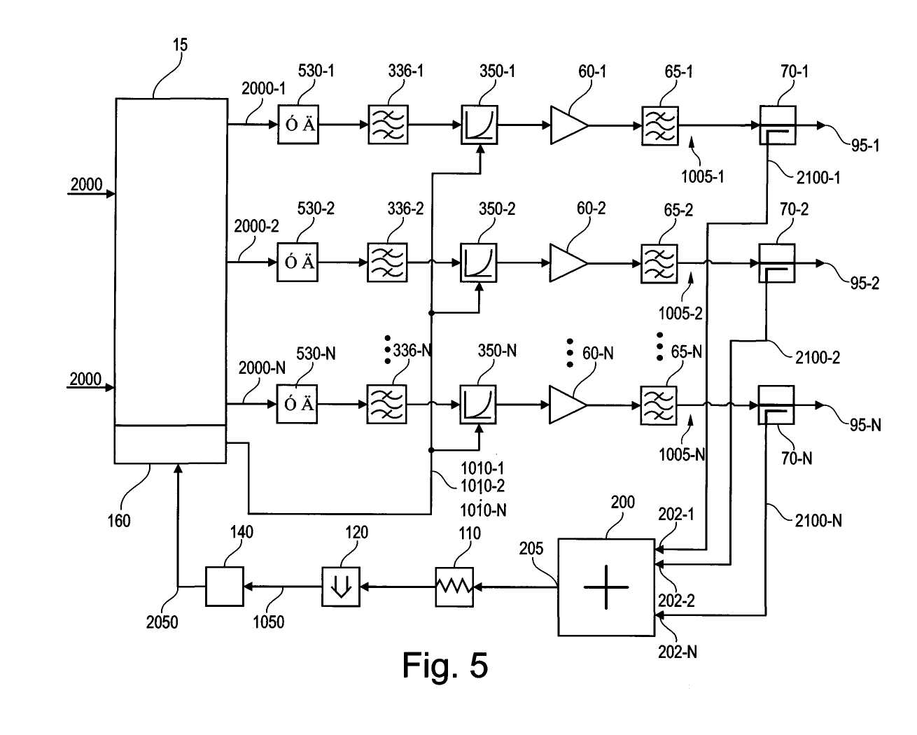

FIG. 5 shows an alternative aspect of the active antenna array 1. The alternative aspect of the active antenna array 1 of FIG. 5 differs from the active antenna arrays 1 of FIGS. 1-3 in that the digital-to-analogue converters 20-1, 20-2, . . . , 20-N are replaced by the delta-sigma digital-to-analogue converters 530-1, 530-2, . . . , 530-N. The delta-sigma digital-to-analogue converters 530-1, 530-2, . . . , 530-N remove the need for an up mixer 35-1, 35-2, . . . , 35-N in the transmission path 30-1, 30-2, . . . , 30-N, as is needed with the digital-to-analogue converters 20-1, 20-2, . . . , 20-N of FIGS. 1-3. It will be apparent that the use of the delta-sigma digital-to-analogue converters 530-1, . . . , 530-N is of interest in order to reduce the system complexity of the radio station 1, as the up mixers are no longer needed.

It will be appreciated that the delta-sigma digital-to-analogue converters 530-1, . . . , 530-N and the digital-to-analogue converters 30-1, . . . , 30-N in combination with the up converters 35-1, . . . , 35-N can be interchanged or used in combination. It will also be appreciated that the down-converter 120 and the analogue-to-digital converter 140 in the feedback path in any of FIGS. 1-5 can be replaced by a delta-sigma ADC and associated filter, with a similar reduction in complexity to that mentioned above with respect to the use of delta-sigma digital to analogue conversion.

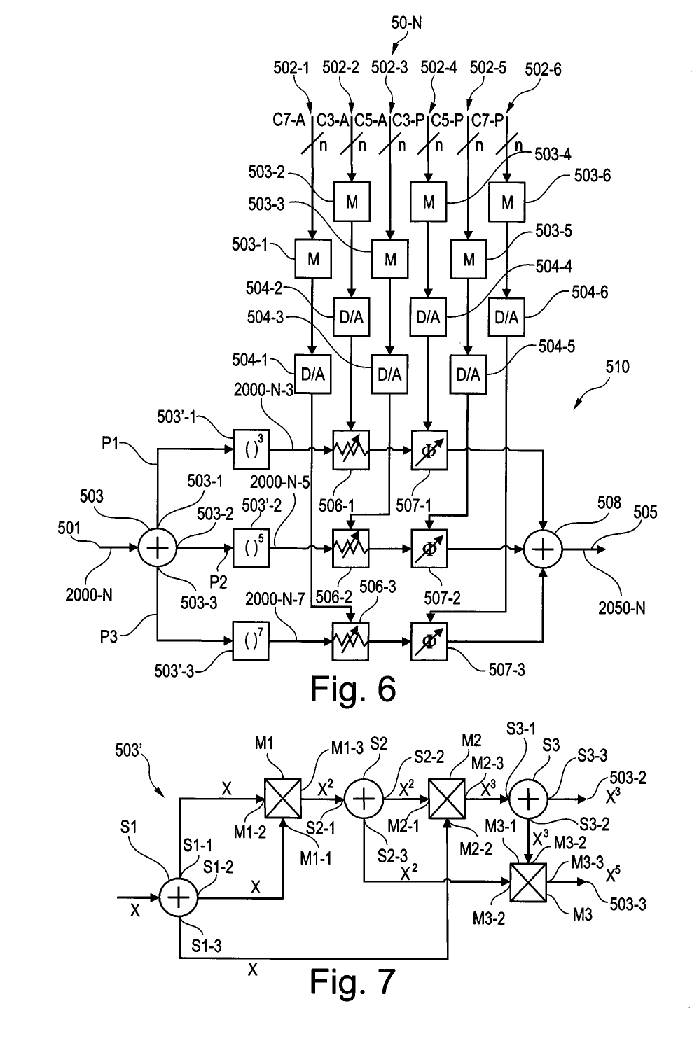

FIG. 6 shows an example of one of the polynomial predistorters 50-N that can be used in one aspect of the disclosure. The polynomial predistorter 50-N works at RF frequencies. A predistorter control system 510 is provided for controlling the polynomial predistorter 50-N. The polynomial predistorter 50-N has a signal input 501 for inputting the analogue RF payload signal 2000-N to which the predistortions are to be imposed. The RF payload signal 2000-N has a main frequency F and a width w defined as the difference between a payload signal maximum frequency Fmax and a payload signal minimum frequency Fmin.

The polynomial predistorter 50-N is adapted to work on in-band inter-modulation product non-linearity signal components of the RF payload signal 2000-N. The inter-modulation product non-linearity signal components result from the non linear transfer characteristics of the amplifier 60-N. In the case of a contiguous payload signal 2000-N, the intermodulation product non-linearity signal component of a 3^{rd} order has a 3^{rd} order spectrum centered on the main frequency, F, and having a width of three times the main frequency spectrum width, i.e. 3W. The intermodulation product non-linearity signal component of a 5^{th} order has a 5^{th} order spectrum centered on the main frequency, F and having a width of five times the main frequency spectrum width, i.e. 5W. The intermodulation product non-linearity signal component of a 7^{th} order has a 7^{th} order spectrum centered on the main frequency, F and having a width of seven times the main frequency spectrum width, i.e. 7W. A contiguous payload signal is defined as a signal which has a spectrum in which all of the frequencies are occupied, between its defined minimum frequency and its defined maximum frequency. A single carrier UMTS W-CDMA signal is an example of a contiguous payload signal, as per this definition.

To correct the non linearities the predistorter 50-N imposes predistortions on each ones of the inter-modulation product non linearity signal components. Preferably, two or three inter-modulation product non linearity signal components are used depending on the quality of the predistortion to be achieved. In FIG. 6, three inter-modulation product non linearity signal components 2000-N-3, 2000-N-5, 2000-N-7 are shown which represent respectively the signal component of the non linearity of the cubic order, the signal component of the non linearity of the quintic order, and the signal component of the non linearity of the 7^{th} order. It will be appreciated that as many non linearity orders as needed may be contemplated.

The analogue RF payload signal 2000-N is passed to a splitter 503. The splitter 503 has three outputs 503-1, 503-2, 503-3 for outputting on three paths P1, P2, P3 three duplicated RF payload signals 2000-N. The paths P1, P2, P3 comprises a decomposition system 503′-1, 503′-2, 503′-3 for decomposing the RF payload signal 2000-N into three inter-modulation product non linearity signal components 2000-N-3, 2000-N-5, 2000-N-7 of the RF payload signal 2000-N. Alternately the splitter 503 and three decompositions systems 503′-1, 503′-2, 503′-3 can be replaced by a single splitter decomposition system 503′ outputting the three inter-modulation product non linearity signal components 2000-N-3, 2000-N-5, 2000-N-7.

The decomposition systems 503′-1, 503′-2, 503′-3, or 503′ based on analogue multipliers can be used for the signal decomposition. An example of a splitter and decomposition system 503′ for obtaining the inter-modulation product non linearity signal components of the cubic and quintic orders will be described with reference to FIG. 7.

For a signal emanating from each order of non-linearity of the order n, predistortion is achieved by altering the amplitude using an amplitude predistortion coefficient Cn-A and by altering the phase using a phase predistortion coefficient Cn-P. There are three signal components emanating from three non linearity orders 2000-N-3, 2000-N-5, 2000-N-7 and six corresponding predistortion coefficients, C3-P, C3-A , C5-P, C5-P, C7-P and C7-A in the example shown in FIG. 6.

The predistortion coefficients C3-P, C3-A , C5-P, C5-A, C7-P and C7-A are passed on a series of coefficient control lines 502-1, 502-n. There is one coefficient control line per coefficient C3-P, C3-A , C5-P, C5-A, C7-P and C7-A. In the example shown on FIG. 6, there are six coefficient control lines. The predistortion coefficients are calculated and updated in the predistortion coefficient calculation unit 160, passed onto the coefficient update path and to the predistorter coefficient control lines 502-1, . . . , 502-n.

The coefficient control line 502-1, . . . , 502-n, comprises a memory storage register 503-1, . . . , 503-n and a low speed digital to analogue converter 504-1, . . . , 504-n. The function of the memory storage register 503-1, . . . , 503-n is to store the last predistortion coefficients for the predistorter. The low speed digital to analogue converter 504-1, . . . , 504-n is adapted to convert the predistortion coefficients outputted digitally from the predistortion coefficient calculation unit 160 into analogue predistortion coefficients. The memory storage register and low speed digital to analogue converter are conventional and will not be discussed further.

The predistorter control system 510 comprises an amplitude controller 506-1, 506-2, 506-3 and phase controller 507-1, 507-2, 507-3 for each high level non-linearity order. The function of the amplitude and phase controllers is to alter the gain and phase of the signals emanating from each order of non-linearity, in order to produce a predistorted payload signal. The phase controllers 507-1, 507-2, 507-3 and amplitude controllers 506-1, 506-2, 506-3 use the respective phase and amplitude predistortion coefficients C3-P, C3-A , C5-P, C5-A, C7-P and C7-A.

The predistorted signal is recomposed within summer 508 adding the different intermodulation signal components and outputted in output 505 comprising the predistorted signal 2050-N.

It will be appreciated that the amplitude and phase controls shown could be replaced by a vector modulator without altering the overall system functionality. Further it is possible to control the predistorter using any other control system.

FIG. 7 shows a detailed view of an example of splitter and decomposition system 503′ suitable for decomposing a main signal x having a main signal frequency F into two non-linearity signal components x³ and x⁵ of third and fifth orders respectively.

The main signal x is passed to a first splitter S1 having three outputs S1-1, S1-2, S1-3. Each one of the outputs S1-1, S1-2, S1-3 has a frequency equal to the main signal frequency F. Two of the outputs S1-1 and S1-2 are passed to two inputs M1-1 and M1-2 of a first analogue multiplier M1. The first analogue multiplier M1 multiplies the main signal with itself and has one output M1-3 which is a signal x² having a main frequency being twice that of the main signal frequency F.

The signal x² is passed to an input S2-1 of a second splitter S2 having two outputs S2-2, S2-3. The first output S2-2 of the second splitter S2 is passed to a first input M2-1 of a second analogue multiplier M2. The second analogue multiplier M2 has a second input M2-2 for inputting the third output S1-3 of the first splitter S1. The second analogue multiplier M2 multiplies the x² signal from the output M1-3 of the first analogue multiplier M1 with the signal x from the output S1-3 of the splitter S1 and has one output M2-3 which is therefore the signal x³, i.e. the cubic non-linearity signal component.

In a similar way, the signal x³ (output M2-3) is passed to an input S3-1 of a third splitter S3 having two outputs S3-2, S3-3. The first output S3-2 of the third splitter S3-1 is passed to a first input M3-1 of a third analogue multiplier M3. The third analogue multiplier M3 has a second input M3-2 for inputting the second output S2-3 of the second splitter S2. The third analogue multiplier M3 has one output M3-3 which is therefore a signal x⁵, i.e. the quintic non-linearity signal component.

It will be appreciated that any number of analogue multipliers and splitters can be used depending on the number of harmonic signal components to be obtained. Analogue multipliers can be fabricated using standard Gilbert-cell techniques or any other form of analogue mixer or multiplier.

The polynomial lineariser or predistorter may be fabricated as an integrated circuit. This allows obtaining a high degree of accuracy and stability for the generation of the non-linearity signal components of different orders—3^{rd}, 5^{th} etc. order non-linearity signal components—required to perform linearization.

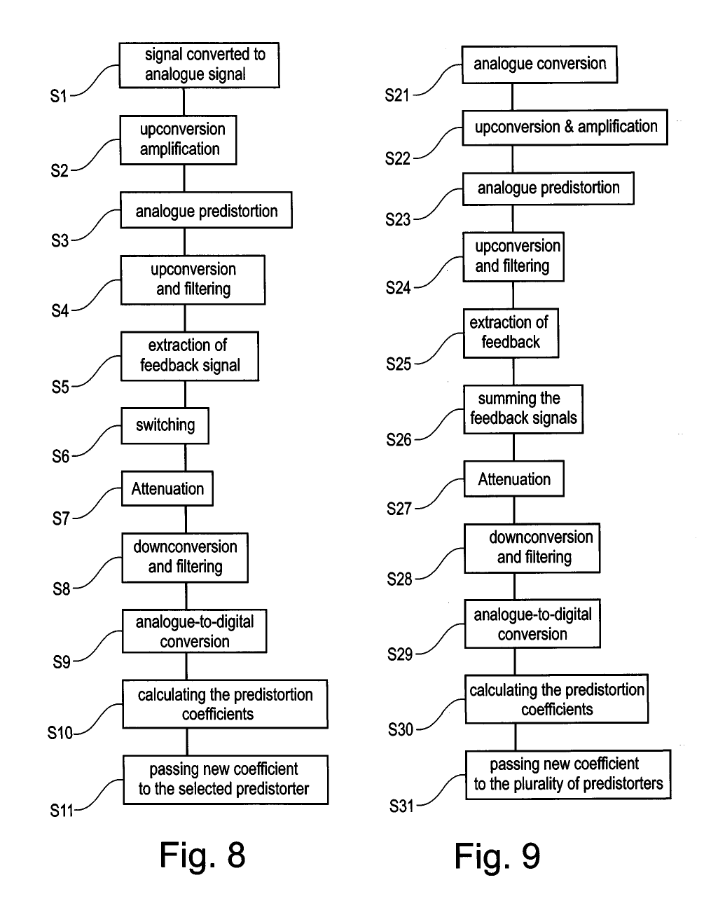

FIG. 8 shows an overview of the method according to one aspect of this disclosure, wherein the method for linearising can be used in conjunction with the active antenna array of FIG. 1.

In step S1, the payload signal 2000 is converted to the analogue payload signal 2000-1, 2000-2, . . . , 2000-N. The analogue payload signal 2000-1, 2000-2, . . . , 2000-N is forwarded along the transmission path 1005-1, 1005-2, . . . , 1005-N. The analogue payload signal 2000-1, 2000-2, . . . , 2000-N is upconverted into intermediate frequencies and amplified by IF amplifier 37-1, 37-2, . . . , 37-N (step S2)

In step S3, the analogue payload signal 2000-1, 2000-2, . . . , 2000-N is passed to the analogue IF predistorter 50-1, 50-2, . . . , 50-N, wherein predistortion coefficients are imposed onto the analogue payload signal 2000-1, 2000-2, . . . , 2000-N forming the predistorted payload signal 2050-1, . . . , 2050-N. The analogue payload signal 2000-1, 2000-2, . . . , 2000-N is the intended signal to be relayed along the transmission paths 1005-1, 1005-2, . . . , 1005-N. The predistorted payload signal 2050-1, . . . , 2050-N is forwarded along the transmission paths 1005-1, 1005-2, . . . , 1005-N. The imposing of the predistortion comprises adding and/or multiplying “the inverse distortion” to the analogue payload signal 2000-1, 2000-2, . . . , 2000-N.

An up-conversion and filtering of the predistorted payload signal 2050-1, 2050-2, . . . , 2050-N (step S4) follows the step S3 of imposing the predistortions onto the selected one of the analogue payload signals 2000-1, 2000-2, . . . , 2000-N. The predistorted payload signal 2050-1, 2050-2, . . . , 2050-N is up converted to RF frequencies in the second up-conversion block 52-1, 52-2, . . . , 52-N. The step S4 of filtering may comprise the use of the band pass filter 56-1, 56-2, . . . , 56-N. The band pass filter 56-1, 56-2, . . . , 56-N may comprise a filtering characteristic as defined by the communication protocol.

The method outlined in FIG. 8 is described with two up-conversion stages as shown in FIG. 1. It will be appreciated that this is not limiting and that the method could comprise a single up-conversion stages as required (as known from FIG. 2). It should be further noted that the method is described with a predistorter 50-1, 50-2, . . . , 50-N working at IF frequencies. It will be appreciated that the predistorter could be working in RF frequencies (as known from FIGS. 3-5). Any combination of up-conversion blocks and predistorter can be contemplated.

An extraction step S5 comprises the extraction of a feedback signal 2100-1, 2100-2, . . . , 2100-N out of one or more of the transmission paths 1005-1, . . . , 1005-N. The extraction step S5 is implemented by the coupler 70-1, . . . , 70-N.

A switching step S6 comprises switching the selected one of the feedback signal 2100-1, 2100-2, . . . , 2100-N into the common feedback path 1050. The switching step S6 may be carried out using the switch 100.

In an attenuation step S7 an attenuation of the selected one of the feedback signals 2100-1, 2100-2, . . . , 2100-N may be achieved. The attenuation step S7 may be of interest in order to adapt a power level of the selected one of the feedback signal 2100-1, 2100-2, . . . , 2100-N to a power level accepted by the digital predistortion coefficient calculation unit 160.

The selected one of the feedback signals 2100-1, 2100-2, . . . , 2100-N is down converted to IF frequencies and filtered by the down-converting and filtering unit 120 at step S8, as is known in the art, following the attenuation step S7.

The down conversion step S8 is followed by an analogue-to-digital conversion step S9. The analogue-to-digital conversion is carried out by the analogue-to-digital converter 140. The analogue-to-digital conversion could be carried out by a delta-sigma analogue-to-digital converter, as is known from the aspect shown in FIG. 5.

It should be noted that the method is described with the analogue-to-digital conversion step S9 carried out after the down conversion step S8. It will be appreciated that this is not limiting and that the analogue-to-digital conversion step S9 could be performed before the down conversion step S8.

The digitised down-converted feedback signal 2100-1, 2100-2, . . . , 2100-N is passed to the predistorter coefficient calculation unit 160, where the predistorter coefficient calculation unit 160 may compile new predistortion coefficients for the selected one of the transmission path 1005-1, . . . , 1005-N (step S10). The predistorter coefficient calculation unit 160 extracts the differences between the selected one of the feedback signals 2100-1, 2100-2, . . . , 2100-N and the payload signal 2000. The extraction step S10 yields the differences mainly introduced due to the nonlinearities of the amplifier 60-1, . . . , 60-N. The differences may comprise a difference in amplitude and/or phase between the payload signal and the selected one of the feedback signals 2100-1, 2100-2, . . . , 2100-N. Methods and devices for extracting the differences between two signals are known in the art and will not be further explained here.

The new updated predistortion coefficients are passed onto the selected one of the coefficient update path 1010-1, 1010-2, . . . , 1010-N, to the selected one of the predistorters 50-1, 50-2, . . . , 50-N (step S11).

An iterative process can be implemented, with each one of the predistorters 50-1, 50-2, . . . , 50-N being updated with the predistortion coefficient calculation unit 160 compiling new coefficients for the selected one of the predistorter 50-1, 50-2, . . . , 50-N corresponding to the selected one of the transmission paths 1005-1, 1005-2, . . . , 1005-N.

FIG. 9 shows an overview of the method according to another aspect of this disclosure. In this aspect the method for linearising is used in conjunction with the active antenna array of FIGS. 2 to 5.

In step S21, a payload signal 2000 is converted to the analogue payload signal 2000-1, 2000-2, . . . , 2000-N. The analogue payload signal 2000-1, 2000-2, . . . , 2000-N is forwarded along the transmission path 1005-1, 1005-2, . . . , 1005-N. The analogue payload signal 2000-1, 2000-2, . . . , 2000-N is upconverted into intermediate frequencies and amplified by IF amplifier 37-1, 37-2, . . . , 37-N (step S22).

In step S23, the analogue payload signal 2000-1, 2000-2, . . . , 2000-N is passed to the analogue IF predistorter 50-1, 50-2, . . . , 50-N, wherein predistortion coefficients are imposed onto the analogue payload signal 2000-1, 2000-2, . . . , 2000-N forming the predistorted payload signal 2050-1, . . . , 2050-N. The analogue payload signal 2000-1, 2000-2, . . . , 2000-N is the intended signal to be relayed along the transmission paths 1005-1, 1005-2, . . . , 1005-N. The predistorted payload signal 2050-1, . . . , 2050-N is forwarded along the transmission paths 1005-1, 1005-2, . . . , 1005-N. The imposing of the predistortion comprises adding and/or multiplying “the inverse distortion” to the analogue payload signal 2000-1, 2000-2, . . . , 2000-N.

An up-conversion and filtering of the predistorted payload signal 2050-1, . . . , 2050-N (step S24) follows the step S23 of imposing the predistortions onto the selected payload signal 2000-1, 200-2, . . . , 2000-N. The step S24 of up-conversion and filtering comprises the use of the amplifiers 60-1, 60-2, . . . , 60-N and of the band pass filters 65-1, 65-2, . . . , 65N. The band pass filter 65-1, 65-2, . . . , 65N may comprise a filtering characteristic as defined by the communication protocol.

An extraction step S25 of extracting comprises the extraction of a feedback signal 2100-1, 2100-2, . . . , 2100-N out of the transmission paths 1005-1, . . . , 1005-N. The extraction is implemented by the coupler 70-1, . . . , 70-N.

A summing step S26 comprises summing, by the adder 200, the feedback signals 2100-1, 2100-2, . . . , 2100-N. The output 205 of the adder 200 is a single composite feedback signal 2150. The output of the adder 205 is passed on the feedback path 1500.

In an attenuation step S27 an attenuating of the composite feedback signal 2150 may be achieved. The attenuation step S27 may be of interest in order to adapt a power level of the composite feedback signal 2150 to a power level accepted by the digital predistortion coefficient calculation unit 160.

The composite feedback signal 2150 is down converted to IF frequencies and filtered by the down-converting and filtering unit 120 at step S28, as is known in the art, following the optional attenuation step S26. The down conversion step S28 is followed by a analogue-to-digital conversion step S29. The analogue-to-digital conversion is carried out by the analogue-to-digital converter 140.

It should be noted that the method is described with the analogue-to-digital conversion step S29 carried out after the down conversion step S28. It will be appreciated that this is not limiting and that the analogue-to-digital conversion step S29 could be performed before the down conversion step S28.

The digitised down-converted composite feedback signal 2150 is passed to the predistorter coefficient calculation unit 160, where the predistorter coefficient calculation unit 160 may extract the differences between the composite feedback signal 2150 and the payload signal 2000-1, . . . , 2000-N (step S30). Methods and devices for extracting the differences between two signals are known in the art and will not be further explained here. The extraction step yields to updated predistortion coefficients for the transmission path 1005-1, . . . , 1005-N.

The new updated predistortion coefficients are passed simultaneously onto the coefficient update path 1010-1, . . . , 101-N to each predistorter 50-1, . . . , 50-N (step S10).

The disclosure further relates to a computer program product embedded on a computer readable medium. The computer program product comprises executable instructions for the manufacture of the active antenna array 1 according to the present invention.

The disclosure relates to yet another computer program product. The yet another computer program product comprises instructions to enable a processor to carry out the method for digitally predistorting a payload signal 2000 according to the invention.

While various embodiments of the present invention have been described above, it should be understood that they have been presented by way of example, and not limitation. It will be apparent to persons skilled in the relevant arts that various changes in form and detail can be made therein without departing from the scope of the invention. In addition to using hardware (e.g., within or coupled to a central processing unit (“CPU”), micro processor, micro controller, digital signal processor, processor core, system on chip (“SOC”) or any other device), implementations may also be embodied in software (e.g. computer readable code, program code, and/or instructions disposed in any form, such as source, object or machine language) disposed for example in a non-transitory computer usable (e.g. readable) medium configured to store the software. Such software can enable, for example, the function, fabrication, modeling, simulation, description and/or testing of the apparatus and methods describe herein. For example, this can be accomplished through the use of general program languages (e.g., C, C++), hardware description languages (HDL) including Verilog HDL, VHDL, and so on, or other available programs. Such software can be disposed in any known non-transitory computer usable medium such as semiconductor, magnetic disc, or optical disc (e.g., CD-ROM, DVD-ROM, etc.). The software can also be disposed as a non-transitory computer data signal embodied in a non-transitory computer usable (e.g. readable) transmission medium (e.g., carrier wave or any other medium including digital, optical, analogue-based medium). Embodiments of the present invention may include methods of providing the apparatus described herein by providing software describing the apparatus and subsequently transmitting the software as a computer data signal over a communication network including the internet and intranets.

It is understood that the apparatus and method describe herein may be included in a semiconductor intellectual property core, such as a micro processor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

### LIST OF REFERENCE NUMERALS

15 digital signal processor (DSP)
20-1, 20-2, . . . , 20-N digital-to-analogue conversion block
28-1, 28-2, . . . , 28-N. first filter
30-1, 30-2, . . . , 30-N up-conversion block
35-1, 35-2, . . . , 35-N up-mixer
36-1, 36-2, . . . , 36-N filter
37-1, 37-2, . . . , 37-N. amplifier
38 a local oscillator
50-1, 50-2, . . . , 50-N predistorter
60-1, 60-2, . . . , 60-N RF amplifier
65-1, 65-2 . . . , 65-N filter
70-1, . . . , 70-N. coupler
95-1, . . . , 95-N antenna elements
100 switch
102-1, 102-2, . . . , 102-N switch inputs
105 switch output
110 attenuator
140 A/D converter
160 predistorter coefficient calculation unit
200 adder
202-1, 202-2, . . . , 202-N adder inputs
205 adder output
320-1, 320-2, . . . , 320-N digital-to-analogue conversion block
328-1, 328-2, . . . , 328-N. first filter
330-1, 330-2, . . . , 330-N up-conversion block
335-1, 335-2, . . . , 335-N up-mixer
336-1, 336-2, . . . , 336-N filter
337-1, 337-2, . . . , 337-N. amplifier
338 a local oscillator
350-1, 350-2, . . . , 350-N predistorter
430-1, 430-2, . . . , 430-N digital to analogue and up-conversion block
438 local oscillator
530-1, . . . , 530-N Delta-sigma digital-to-analogue converters
510 Predistorter control system
506-1, 506-2, 506-3 amplitude controller
507-1, 507-2, 507-3 phase controller
C3-P, C3-A, C5-P, C5-P, . . . Cn-P and Cn-A predistortion coefficients
coefficient control line 502-1, . . . 502-2n
503 splitter
503′-1, 503′-2, 503′-3 decompositions systems
M1, M2, M3: analogue multipliers
503-1 503-2, 503-3 output
P1, P2, P3 paths
503′ splitter and decomposition system
S1, S2, S3 splitter
S1-1, S1-2, S1-3 1^{st} splitter outputs
S2-1 2^{nd} splitter input
S2-2, S2-3 2^{nd} splitter outputs
S3-1 3^{rd} splitter input
S3-2, S3-3 3^{rd} splitter outputs
M1-1, M1-2 1^{st} analogue multiplier inputs
M1-3 1^{st} analogue multiplier output
M2-1, M2-2 2^{nd} analogue multiplier inputs
M2-3 2^{nd} analogue multiplier output
M3-1, M3-2 3rd analogue multiplier inputs
M3-3 3rd analogue multiplier output

### Paths

1000-1, 1000-2, . . . , 1000-N antenna path
1005-1, 1005-2, . . . , 1005-N transmission path
1010-1, 1010-2, 1010-N coefficient update path
1050 feedback path

### Signals

2000 Payload signal
2000-1, . . . , 2000-N, analogue payload signal
2050-1, 2050-2, . . . , 2050-N predistorted payload signal
2100-1, 2100-2, . . . , 2100-N Feedback signal
2150 single composite feedback signal
2000-N-3, 2000-N-5, 2000-N-7 harmonic signal component

### CROSS REFERENCE TO OTHER APPLICATIONS

This application is related to U.S. patent application Ser. No. 12/732,613 entitled: “ACTIVE ANTENNA ARRAY HAVING ANALOGUE TRANSMITTER LINEARISATION AND A METHOD FOR PREDISTORTION OF RADIO SIGNALS”, filed Mar. 26, 2010 and U.S. patent application Ser. No. 12/732,631 entitled: “ACTIVE ANTENNA ARRAY HAVING A SINGLE DPD LINEARISER AND A METHOD FOR PREDISTORTION OF RADIO SIGNALS”, filed Mar. 26, 2010. The present application is also related to U.S. patent application Ser. No. 12/648,028 entitled: “METHOD FOR DIGITALLY PREDISTORTING A PAYLOAD SIGNAL AND RADIO STATION INCORPORATING THE METHOD”, filed on Dec. 28, 2009.

The entire contents of the applications are incorporated herein by reference.

1. An active antenna array for a mobile communications network comprising:
a digital signal processor connected to a plurality of digital-to-analogue conversion blocks;
a plurality of antenna elements;
a plurality of transmission paths, whereby an individual one of the plurality of transmission paths is connected between an individual one of the digital-to-analogue conversion blocks and an individual one of the plurality of antenna elements, whereby an individual one of the plurality of transmission paths comprises a predistorter and a coupler;
a plurality of paths connected between an individual one of the couplers and a single combiner
a single feedback path connected between the single combiner and a predistorter coefficient calculation unit; and
a coefficient update path connected between the predistorter coefficient calculation unit and at least an individual one of the predistorters.

2. The active antenna array of claim 1, wherein the combiner is one of a multi-way switch or an adder.

3. The active antenna array of claim 1, wherein the digital to analogue conversion block is one of a digital-to-analogue converter, a delta-sigma digital-to-analogue converter or a pair of digital-to-analogue converters supplying I & Q signals.

4. The active antenna array of claim 4, wherein the pre-distorter coefficient calculation unit is located within the digital signal processor.

5. The active antenna array of claim 1, comprising a predistorter control system for controlling the predistorter.

6. The active antenna array of claim 5, wherein the predistorter control system comprises at least one of an amplitude controller and a phase controller.

7. A method for predistortion of radio signals comprising:
predistorting two or more of a plurality of analogue payload signals, thereby obtaining at least two predistorted payload signals,
amplifying the at least two predistorted payload signals,
extracting a portion of one or more of the at least two predistorted payload signals as a single feedback signal, and
adapting the predistorting of the two or more of the plurality of analogue payload signals by comparing the single feedback signal with at least one of the two or more of the plurality of analogue payload signals.

8. The method according to claim 7, further comprising switching between individual ones of the feedback signals; and using the switched one of the individual ones of the feedback signals for adapting the predistorting of a corresponding one of the plurality of analogue payload signals.

9. The method according to claim 7, further comprising forming an composite feedback signal from a plurality of the at least one predistorted payload signals; and using the composite feedback signal for adapting the predistorting of a plurality of the analogue payload signals.

10. A computer program product comprising a non-transitory computer-usable medium having control logic stored therein for causing a computer to manufacture an active antenna array for a mobile communications network, the active antenna array comprising:
a digital signal processor connected to a plurality of digital-to-analogue conversion blocks;
a plurality of antenna elements;
a plurality of transmission paths, whereby an individual one of the plurality of transmission paths is connected between an individual one of the digital-to-analogue conversion block and an individual one of the plurality of antenna elements, whereby an individual one of the plurality of transmission paths comprises a predistorter and a coupler;
a plurality of paths connected between an individual one of the couplers and a single combiner
a single feedback path connected between the single combiner and a predistorter coefficient calculation unit; and
a coefficient update path connected between the predistorter coefficient calculation unit and at least an individual one of the predistorters.

11. A computer program product comprising a non-transitory computer-usable medium having control logic stored therein for causing an active antenna to execute a method for receiving a plurality of individual radio signals comprising:
first computer readable code means for predistorting two or more of a plurality of analogue payload signals, thereby obtaining at least two predistorted payload signal;
second computer readable code means for amplifying the at least two predistorted payload signal
third computer readable code means for extracting a portion of one or more of the at least two predistorted payload signal as a single feedback signal
fourth computer readable control means for adapting the predistorting of the two or more of the plurality of analogue payload signals by comparing the single feedback signal with at least one of the two or more of the plurality of analogue payload signals.
